(19) United States
(12) Patent Application Publication
(10) Pub. No.: US 2008/0026191 A1
(43) Pub. Date: Jan. 31, 2008

(54) Compounds, compositions and processes

(75) Inventors: Clive Edwin Foster, Blackley (GB); Roy Bradbury, Merseyside (GB); Lynn Patricia Bradbury, Merseyside (GB)

Correspondence Address: MORGAN LEWIS & BOCKIUS LLP, 1111 PENNSYLVANIA AVENUE NW, WASHINGTON, DC, 20004, US

(73) Assignee: Fujifilm Imaging Colorants Limited

(21) Appl. No.: 11/878,100

(22) Filed: Jul. 20, 2007

(30) Foreign Application Priority Data
Jul. 22, 2006 (GB) 0614589.0

(51) Int. Cl. C09D 11/02; B41M 5/00; C09B 62/347; C09B 62/447

(52) U.S. Cl. 428/195.1; 106/31.13; 534/617; 534/619

(57) ABSTRACT

The invention provides a compound of Formula (1-1) or Formula (1-2) or a salt thereof: 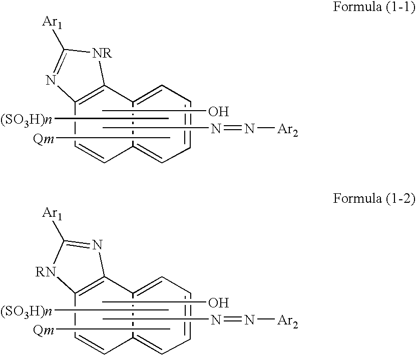 wherein:
Ar₁ and Ar₂ each independently represent an optionally substituted aryl or heteroaryl group with the proviso that where Ar₁ is phenyl substituted with and azo group it is substituted with the azo group at the para position; R represents H, optionally substituted alkyl, or optionally substituted aryl; Q is a substituent, which may be another OH group; n is an integer from 1 to 4; m is an integer from 0 to 4, wherein each Q may be the same or different in the case where m is more than 1; and n+m is not greater than 4;
   with the proviso that the compound is not one of the following compounds (i) and (ii) and the salt is not a salt thereof: 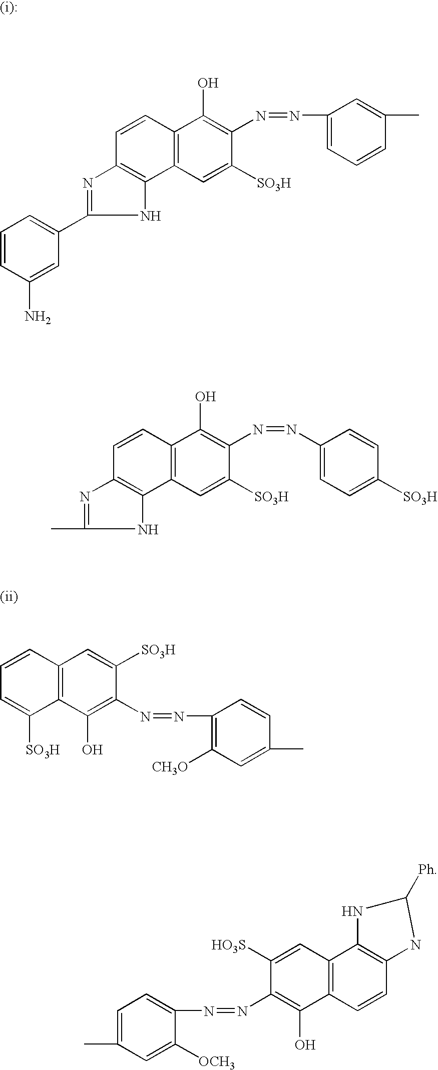 Also provided by the invention are ink compositions, printing processes, especially ink jet printing processes, printed substrates, ink cartridges and the like.

This invention relates to compounds, to compositions and to their use in printing, particularly but not exclusively, ink jet printing (“IJP”). IJP is a non-impact printing technique in which droplets of ink are ejected through a fine nozzle onto a substrate without bringing the nozzle into contact with the substrate.

There are many demanding performance requirements for dyes and inks used in IJP. For example, it is desirable that they provide sharp, non-feathered images having good optical density, water-fastness, light-fastness and resistance to fading in the presence of oxidising air pollutants (e.g. ozone). The inks are often required to dry quickly when applied to a substrate to prevent smudging, but they should not form a crust over the tip of an ink jet nozzle because this will stop the printer from working. The inks should also be stable to storage over time without decomposing or forming a precipitate which could block the fine nozzle.

An object of the present invention is to provide dyes, in particular, but not exclusively, magenta and black dyes, for ink jet printing having improvements in one or more of the above mentioned performance requirements. Other objects of the present invention will be apparent on reading the following description.

JP 58-174471 and JP 2000-265099 describes the use of CI Direct Red 6 and CI Direct Red 55 for use in ink jet recording. Such dyes comprise a phenyl group attached to a benzimidazole moiety, in which a phenyl group is meta-substituted with a naphthyl azo group. However, there still exists room for improvement in performance requirements for good ink jet printing.

According to one aspect of the present invention there is provided a compound of Formula (1-1) or Formula (1-2) or a salt thereof: 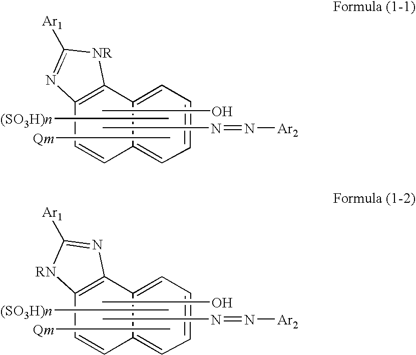
wherein:
Ar₁ and Ar₂ each independently represent an optionally substituted aryl or heteroaryl group with the proviso that where Ar₁ is phenyl substituted with an azo group it is substituted with the azo group at the para position;
R represents H, optionally substituted alkyl, or optionally substituted aryl;
Q is a substituent, which may be another OH group;
n is an integer from 1 to 4;
m is an integer from 0 to 4, wherein each Q may be the same or different in the case where m is more than 1; and
n+m is not greater than 4;
   with the proviso that the compound is not one of the following compounds (i) and (ii) and the salt is not a salt thereof

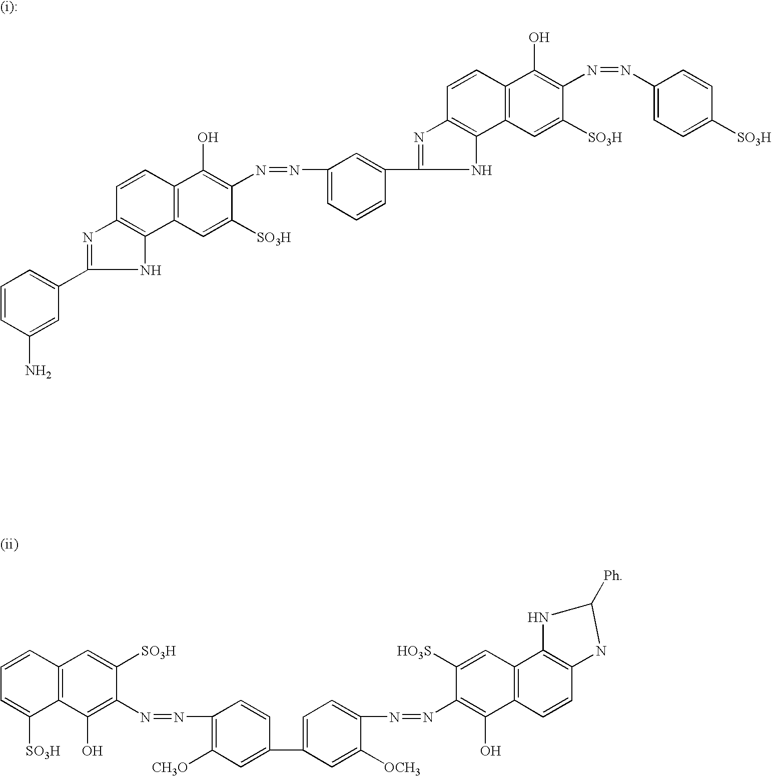

The two compounds (i) and (ii) disclaimed are disclosed in U.S. Pat. No. 3,926,835 and DE 1081990 respectively in technical fields unrelated to ink jet printing.

Preferably, the compounds of the present invention are not metallised.

For convenience, preferred embodiments may be written in this specification as embodiments of Formula (1-1), i.e. having the sub-structure:

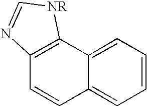

However, it should be understood that the preferred embodiments, including in-the claims, may also be written as the analogous embodiments of the isomeric Formula (1-2), i.e. having the sub-structure:

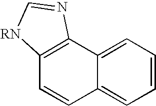

The compounds of the present invention are dyes which are suitable for printing, preferably ink jet printing. However, the compounds may have other uses such as dyeing textiles.

The compounds may range in colour. Ink jet ink sets typically comprise at least a black ink, a magenta ink, a cyan ink and a yellow ink. Compounds of the present invention may be suitable for black, red or magenta inks. It should be understood that colour can be fine tuned to cover a range of shades.

According to another aspect of the present invention there is provided an ink composition which comprises a liquid medium and a compound of Formula (1-1) or Formula (1-2) or a salt thereof. The ink composition of the present invention is preferably suitable for ink jet printing.

According to yet another aspect of the present invention there is provided a process for printing an image on a substrate, the process comprising applying to the substrate an ink composition which comprises a liquid medium and a compound of Formula (1-1) or Formula (1-2) or a salt thereof. The ink composition is preferably applied by ink jet printing. In the process for printing according to the present invention, the compound in the composition may include either of the compounds (i) and (ii) above and the salt may include a salt thereof. These compounds have not previously been suggested for such printing.

The process for printing an image on a substrate is preferably an ink jet printing process. In other words, the process is preferably a printing process in which droplets of the ink composition are ejected through a fine nozzle onto the substrate without bringing the nozzle into contact with the substrate. Thus, preferably, the ink composition is applied to the substrate by means of an ink jet printer. The term image herein includes, without limitation, both a graphic image (including a photorealistic image) and text.

With regard to the NR group in the fused imidazole ring, preferably, R is H. In the case where R is alkyl, it is preferably C₁₋₄alkyl, especially C₁₋₂alkyl. In the case where R is aryl, it is preferably phenyl or naphthyl, especially phenyl.

The OH group shown in Formula (1-1) or Formula (1-2) may be present at any available position on the naphthyl group and on either ring of the naphthyl group. Preferably, the OH group is present on the opposite ring of the naphthyl group to the ring which carries the fused imidazole group. More preferably, the OH group is present at the “1” position (also termed alpha position) on the naphthyl group, thus:

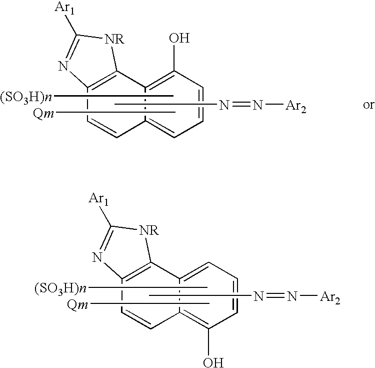

Preferably, n is 1 or 2. More preferably, n is 1. The sulpho (i.e. —SO₃H) group(s) may constitute one or more of the water solubilising groups of the compound of Formula (1-1) or Formula (1-2) as hereinafter described. The sulpho group(s) may be present in a salt form, especially an alkali metal or ammonium ion salt form. The sulpho group(s) is/are preferably in a salt form.

The sulpho group(s) may be present at any available position on the naphthyl group shown in Formula (1-1) or Formula (1-2) and on either ring of the naphthyl group. Preferably, at least one sulpho group is present on the opposite ring of the naphthyl group to the ring which carries the imidazole group. Preferably, at least one sulpho group is present on the same ring of the naphthyl group as the OH group. More preferably, at least one sulpho group is present at the 3-position (with the hydroxy group being at the position denoted as the 1-position), thus:

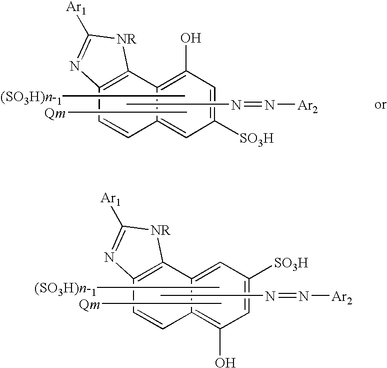

Where n is 2 or more (especially where n is 2), preferably at least one sulpho group is present on each ring of the naphthyl group.

Q may be any optional substituent, including another OH group. Preferably m is 0 or 1, more preferably 0. The group represented by Q may be present at any available position on the naphthyl group shown in Formula (1-1) or Formula (1-2), including being present on either ring of the naphthyl group. Preferably, Q is selected from the following list of substituents: optionally substituted alkyl, optionally substituted alkoxy, optionally substituted aryl, optionally substituted heteroaryl, optionally substituted aryloxy, optionally substituted amino, hydroxy, halogen, cyano, nitro, silyl, silyloxy, azo (especially aryl azo), phosphato (i.e. —PO₃H₂), phosphinic acid (i.e. —PO(OH)R¹), —COOR¹, —OCOOR¹, —OCOR¹, —COR¹, —CONR¹R², —OCONR¹R², —SR¹, —SO₂NR¹R², —SO₂R¹, or sulfinic acid (i.e. —SO(OH)R¹) wherein R¹ and R² each independently represent H, optionally substituted alkyl, or optionally substituted aryl.

In this specification, any acid groups, including sulpho, phosphato and carboxy (i.e. COOH), may be present in a salt form and are preferably present in a salt form. Preferred salt forms are discussed below.

The azo group which links Ar₂ to the naphthyl group may be present at any available position on the naphthyl group shown in Formula (1-1) or Formula (1-2) and on either ring of the naphthyl group. Preferably, the azo group which links Ar₂ to the naphthyl group is present on the opposite ring of the naphthyl group to the ring which carries the imidazole group. More preferably, the azo group which links Ar₂ to the naphthyl group is present at the position ortho or para (more preferably ortho) to the hydroxy group, as in the following preferred embodiments for example:

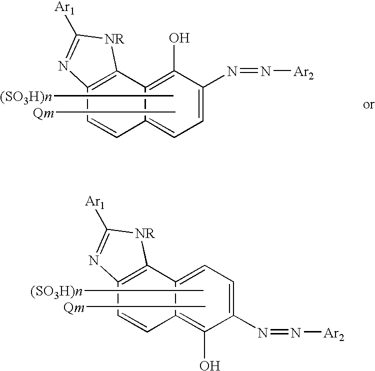

When the preferred position of at least one of the sulpho groups is also considered, more preferred structures of the compounds may be represented by the following formulae:

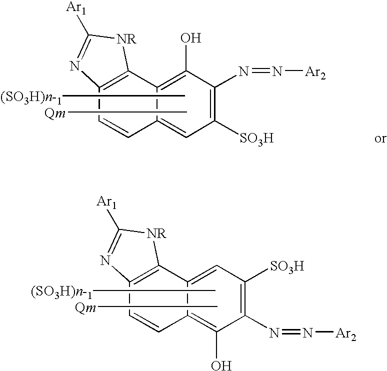

Ar₁ and Ar₂ are each independently optionally substituted aryl or optionally substituted heteroaryl groups. Preferably, at least one of Ar₁ and Ar₂ is an optionally substituted aryl group. Preferably, Ar₁ and Ar₂ are each independently optionally substituted aryl. More preferably, Ar₁ and Ar₂ are each independently optionally substituted phenyl or naphthyl. Still more preferably, Ar₁ and Ar₂ are each independently optionally substituted phenyl. In the case where Ar₂ is phenyl and is substituted with an azo group it is preferably para-substituted with the azo group.

Preferably, Ar₁ and Ar₂ are each independently substituted by up to 5 substituents. More preferably, Ar₁ and Ar₂ are each independently substituted by up to 4 substituents and most preferably Ar₁ and Ar₂ are each independently substituted by up to 3 substituents.

Preferably, the optional substituents on Ar₁ and Ar₂ are independently selected from optionally substituted alkyl, optionally substituted alkoxy, optionally substituted aryl, optionally substituted heteroaryl, optionally substituted aryloxy, optionally substituted amino, hydroxyl, halogen, cyano, nitro, silyl, silyloxy, azo (especially arylazo or heteroarylazo), sulpho, phosphate, COOR¹, OCOOR¹, OCOR¹, COR¹, CONR¹R², OCONR¹R², SR¹, SO₂NR¹R², or SO₂R¹, wherein R¹ and R²are as defined above. Preferably, the optional substituents for Ar₁ and Ar₂ do not comprise a free amino group, i.e. of the form —NR¹R².

Any two suitable substituents on Ar₁ and/or any two suitable substituents on Ar₂ may link together to form a ring, i.e. a fused ring on Ar₁ and/or Ar₂. Such a fused ring may be an aliphatic or aromatic (including heteroaromatic) ring.

Preferably, the optional substituents on Ar₁ are selected from sulpho, carboxy, phosphato, hydroxy, nitro, halogen, cyano, optionally substituted amino, optionally substituted C₁₋₄alkyl, optionally substituted C₁₋₄alkoxy, optionally substituted aryl or heteroaryl and azo (especially optionally substituted arylazo or optionally substituted heteroarylazo).

More preferably, the optional substituents on Ar₁ are selected from: sulpho, carboxy, phosphato, optionally substituted amino, optionally substituted, optionally substituted arylazo, optionally substituted heteroarylazo and optionally substituted heteroaryl. A preferred heteroarylazo is pyrazolylazo. Preferred pyrazolyl groups are defined hereinafter.

Preferably, the optional substituents on Ar₂ are selected from: sulpho, carboxy, phosphato, hydroxy, nitro, halogen, cyano, optionally substituted amino (especially optionally substituted acylamino), optionally substituted C₁₋₄alkyl, optionally substituted C₁₋₄alkoxy, optionally substituted arylazo and optionally substituted heteroarylazo. A preferred heteroaryl is pyrazolyl. Preferred pyrazolyl groups are defined hereinafter.

In a first preferred embodiment, Ar₂ is at least substituted with an optionally substituted arylazo or heteroarylazo group, more preferably an optionally substituted arylazo group, still more preferably an optionally substituted phenylazo or naphthylazo group and most preferably an optionally substituted phenylazo group. Such compounds may be useful for magenta or black inks. Preferably, where Ar₂ is phenyl, it is para-substituted with the azo group (i.e. para-substituted relative to the position of the azo linkage which links Ar₂ to the central naphthyl group). Where Ar₂ is substituted with an optionally substituted heteroarylazo group, preferred optionally substituted heteroarylazo is optionally substituted pyridyl, pyridone, pyrazolyl or 1,2,4-triazole azo (especially pyrazolylazo). Preferred optional substituents for the azo group are selected from optionally substituted alkyl, optionally substituted alkoxy, optionally substituted aryl, optionally substituted heteroaryl, optionally substituted aryloxy, optionally substituted amino, hydroxyl, halogen, cyano, nitro, optionally substituted aryl or heteroaryl azo, sulpho, phosphato, COOR¹, OCOOR¹, OCOR¹, COR¹, CONR¹R², OCONR¹R², SR¹, SO₂NR¹R², or SO₂R¹ and more preferred among these are sulpho, carboxy or phosphato.

In other words, in the first preferred embodiment described above, desirably the compound of Formula (1-1) or Formula (1-2) has a Formula (1A): 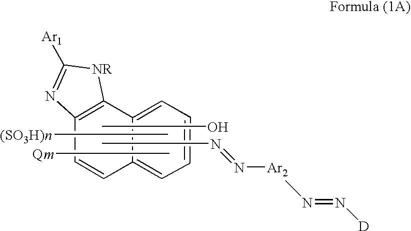
wherein D is an optionally substituted aryl or heteroaryl group, more preferably an optionally substituted aryl group, still more preferably an optionally substituted phenyl or naphthyl group and most preferably an optionally substituted phenyl group. D is preferably at least substituted with at least one water solubilising group, preferably selected from sulpho, carboxy and phosphate, more preferably sulpho. D may also be further substituted, e.g. with groups selected from optionally substituted alkyl, optionally substituted alkoxy, nitro, optionally substituted amino or another optionally substituted aryl or heteroaryl azo group.

In a second preferred embodiment, Ar₁ is not substituted with an azo group. In such case where Ar₁ is not substituted with an azo group, Ar₁ is preferably at least substituted with at least one water solubilising group, preferably selected from sulpho, carboxy and phosphate, more preferably sulpho. In the second preferred embodiment where Ar₁ is not substituted with an azo group, Ar₂ may or may not be substituted with an azo group but preferably is not substituted with an azo group. In the case where Ar₂ is not substituted with an azo group, Ar₂ is preferably substituted with at least one water solubilising group, preferably selected from sulpho, carboxy and phosphato (especially sulpho and carboxy). Accordingly, in such second preferred embodiment, desirably a compound is represented by the following formula: 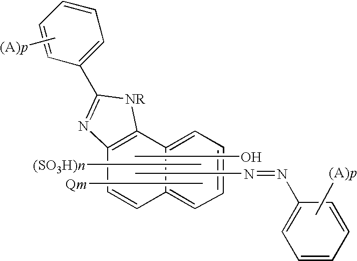
more especially of the following formulae: 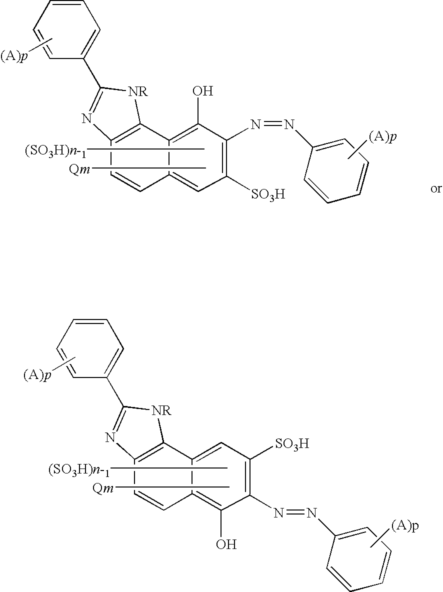
wherein p is an integer from 0 to 4 and each A independently is a substituent selected from optionally substituted alkyl, optionally substituted alkoxy, optionally substituted aryl, optionally substituted heteroaryl, optionally substituted aryloxy, optionally substituted amino, hydroxy, halogen, cyano, nitro, silyl, silyloxy, sulpho, phosphato, COOR¹, OCOOR¹, OCOR¹, COR¹, CONR¹R², OCONR¹R², SR¹, SO₂NR¹R², or SO₂R¹, wherein R¹ and R² are as defined above. Preferably, each A independently is a substituent selected from optionally substituted alkyl, optionally substituted alkoxy, sulpho, COOH, phosphate, nitro, cyano, halogen, hydroxy and optionally substituted amino.

In a third preferred embodiment, Ar₁ is at least substituted with an optionally substituted heteroaryl group or an azo group. More preferably, Ar₁ is at least substituted with an azo group. Preferably, the azo group is an optionally substituted arylazo group or an optionally substituted heteroarylazo group (e.g. a pyrazolylazo group). More preferably, Ar₁ is at least substituted with an optionally substituted heteroarylazo group, preferably a pyrazolylazo group. Where Ar₁ is substituted with an optionally substituted arylazo group, the optionally substituted arylazo group preferably comprises an optionally substituted phenylazo group. The features of the third preferred embodiment may be used particularly, but not exclusively, in conjunction with the features of the first preferred embodiment. Such compounds may be useful for magenta or black, preferably black inks.

In view of the foregoing, in a further preferred embodiment, the compound of Formula (1-1) or Formula (1-2) may have a Formula (1B): 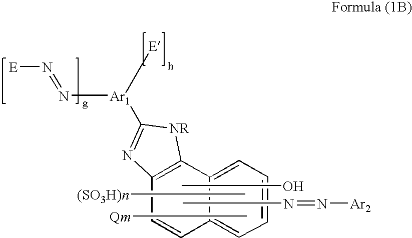
wherein E is an optionally substituted aryl group, or an optionally substituted heteroaryl group (preferably a pyrazolyl group), E′ is an optionally substituted heteroaryl group (preferably a pyrazolyl group) and g and h are each either 0 or 1 with the proviso that g and h cannot both be 0 or both be 1 at the same time (i.e. one and only one of the E-N═N— and E′- groups may be present). The E-N═N— and E′- groups are para-substituted on Ar₁ where Ar₁ is phenyl.

In a further preferred embodiment, the compound of Formula (1-1) or Formula (1-2) may have a Formula (1C): 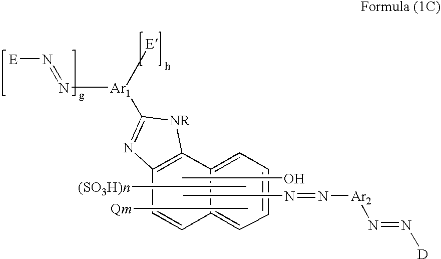
where D is defined above.

Preferably, E is a pyrazolyl group of Formula (2a) or (2b) and tautomers thereof and E′ is a pyrazolyl group of Formula (2a′) or (2b′) and tautomers thereof. 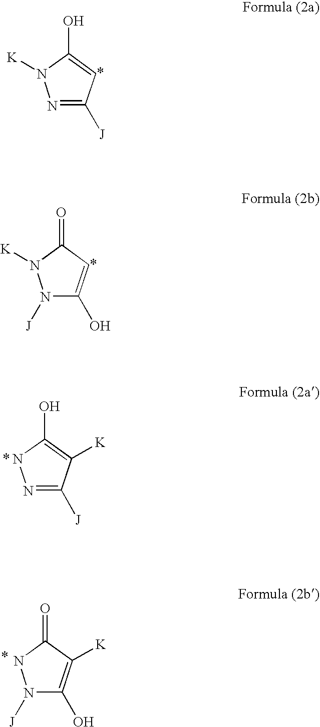
wherein:
* represents the point of attachment to the azo linkage in the case of E and the point of attachment to Ar₁ in the case of E′; and
J and K each independently represents H, optionally substituted alkyl, optionally substituted cycloalkyl, optionally substituted alkoxy, optionally substituted aryl, optionally substituted heteroaryl, optionally substituted aryloxy, optionally substituted amino, azo, halogen, cyano, hydroxyl, thio, nitro, sulpho, phosphate, COOR¹, OCOOR¹, OCOR¹, COR¹, CONR¹R², OCONR¹R², SR¹, SO₂NR¹R², or SO₂R¹, wherein R¹ and R²are as defined above.

Preferably, J is selected from H, optionally substituted C₁₋₄alkyl (preferably methyl or ethyl, more preferably methyl) or carboxy, and most preferably is carboxy. In the case of Formula (2a), more preferably J is optionally substituted C₁₋₄alkyl (especially methyl) or carboxy, and most preferably is carboxy. In the case of Formula (2b), more preferably J is H or optionally substituted C₁₋₄alkyl (especially methyl).

In Formula (2a) or (2b) preferably K is an optionally substituted aryl group, more preferably an optionally substituted phenyl or naphthyl group and most preferably an optionally substituted phenyl group. Where K is an optionally substituted aryl group, K is preferably at least substituted with at least one water solubilising group, preferably selected from sulpho, carboxy and phosphato, more preferably sulpho.

In Formula (2a′) or (2b′) preferably K is an azo group, more preferably an optionally substituted aryl azo group such as optionally substituted phenyl or naphthyl azo, and especially an optionally substituted phenyl azo group.

More preferably, E and E′ are of Formula (2a) and (2a′) respectively. In other words, the compound of Formula (1-1) or Formula (1-2) preferably has a Formula (1D), wherein E and E′ are groups of Formula (2a) and (2a′) respectively:

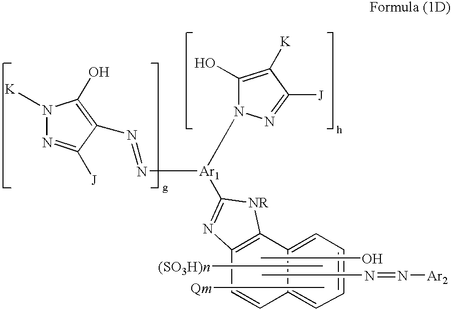

In respect of the optional substituents described herein, e.g. on Ar₁, Ar₂, D and/or E and E′ (i.e. including groups J and K on E and E′), unless specified otherwise: a preferred optionally substituted alkyl is optionally substituted C₁₋₄alkyl and more preferred is C₁₋₄alkyl substituted with at least one of sulpho, carboxy, phosphato, C₁₋₄alkoxy, amino and hydroxy; a preferred optionally substituted alkoxy is optionally substituted C₁₋₄alkoxy and more preferred is C₁₋₄alkoxy substituted with at least one of sulpho, carboxy, phosphato, C₁₋₄alkoxy, amino and hydroxy; a preferred optionally substituted aryl is optionally substituted phenyl or naphthyl (especially phenyl) and more preferred is phenyl or naphthyl (especially phenyl) substituted with at least one of sulpho, carboxy, phosphato, C₁₋₄alkoxy, amino and hydroxy; a preferred optionally substituted heteroaryl is optionally substituted pyridyl, pyridone, pyrazolyl or 1,2,4-triazole; a preferred optionally substituted amino is amino carrying one or two optionally substituted aryl groups, one or two optionally substituted C₁₋₄alkyl groups or an acyl group (e.g. acetyl); and a preferred azo group is optionally substituted carbocyclic azo, optionally substituted heterocyclic azo or alkenyl azo, and more preferred among these is optionally substituted aryl azo (especially phenyl azo) or optionally substituted heteroaryl azo, wherein preferred optional substituents for the azo group are selected from optionally substituted alkyl, optionally substituted cycloalkyl, optionally substituted alkoxy, optionally substituted aryl, optionally substituted heteroaryl, optionally substituted aryloxy, optionally substituted amino, hydroxyl, halogen, cyano, nitro, optionally substituted carbocyclic azo or optionally substituted heterocyclic azo, sulpho, phosphato, COOR¹, OCOOR¹, OCOR¹, COR¹, CONR¹R² (with the proviso that it is not a substituent on X), OCONR¹R², SR¹, SO₂NR¹R², or SO₂R¹ and more preferred is that the azo group is substituted by at least one sulpho, carboxy or phosphato group.

In one embodiment, Ar₂ is preferably substituted by 1 to 4, more preferably 1 to 3, and most preferably 2 to 3, substituents.

In that preferred embodiment described above where Ar₂ is substituted at least with an optionally substituted arylazo or heteroarylazo group (e.g. group —N═N-D described above), preferably Ar₂ is also substituted with one or more, more preferably one or two, still more preferably two, groups selected from optionally substituted C₁₋₄alkyl (especially methyl, ethyl and propyl), optionally substituted C₁₋₄alkoxy (especially methoxy, ethoxy and propoxy) and optionally substituted —O—(CH₂)₁₋₄—OH (especially —O—CH₂—OH and —O—C₂H₄—OH). A preferred optional substituent for such groups is sulpho, e.g. in —O—C₃H₆SO₃H. Most preferably Ar₂ is also substituted with one or more, more preferably one or two, still more preferably two —O—(CH₂)₁₋₄—OH groups, wherein the —O—(CH₂)₁₋₄—OH is preferably —O—C₂H₄—OH, such that most preferably of all Ar₂ carries two —O—C₂H₄—OH groups.

In one particular preferred embodiment, Ar₂ is therefore of Formula (2e): 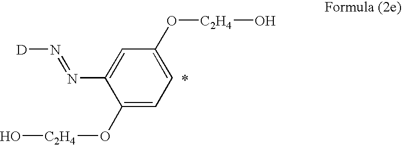
wherein * represents the point of attachment to the azo linkage which links Ar₂ to the naphthyl group of the compound of Formula (1-1) or Formula (1-2) and D is as herein defined.

Preferably the compound of Formula (1-1) or Formula (1-2) has at least two water solubilising groups. Preferably, at least one water solubilising group is present on Ar₁ and/or Ar₂. The water solubilising groups may be any groups able to increase the aqueous solubility of the compound of Formula (1-1) or Formula (1-2). Thus, for example, it may be an ionisable anionic or cationic group or a non-ionic group. Preferably, the water solubilising groups comprise an anionic ionisable group. More preferably, the water solubilising groups comprises a group selected from carboxy, sulpho and phosphate. Preferably, at least two, more preferably all, of the water solubilising groups are selected from carboxy, sulpho and phosphate. Further preferably, the water solubilising groups include at least one sulpho group. Especially preferably the compound of Formula (1-1) or Formula (1-2) has at least two sulpho groups, more preferably two or three sulpho groups.

Preferably the compound of Formula (1-1) or Formula (1-2) has a solubility in water at 25° C. of at least 1% and more preferably the compound of Formula (1-1) or Formula (1-2) has a solubility in water at 25° C. of at least 2.5%. It is particularly preferred that the compound of Formula (1-1) or Formula (1-2) has a solubility in water at 25° C. of at least 5%.

In this specification, any group or substituent may be optionally substituted even if this is not explicitly stated. In this specification, where any substituent is itself defined as being optionally substituted it may be substituted by one or more of any of the substituents described herein.

In this specification, unless the context indicates otherwise, preferred aryl groups are phenyl and naphthyl and preferred heteroaryl groups are pyridyl, pyrazolyl and 1,2,4-triazole.

The term ‘alkyl’ as used herein includes moieties having a different degree of saturation and/or valence, e.g. moieties that comprise double bonds or triple bonds, such as alkenyl or alkynyl. In this specification, unless the context indicates otherwise, preferred alkyl groups are C₁₋₄alkyl. The term ‘alkyl’ as used herein includes cycloalkyl.

The term ‘halogen’ or ‘halo’ as used herein signifies fluoro, chloro, bromo and iodo. In this specification, unless the context indicates otherwise, preferred halogen groups are fluoro, chloro and bromo.

Unless the context clearly indicates otherwise; a group herein which comprises a chain of three or more atoms signifies a group in which the chain wholly or in part may be linear, branched and/or form a ring (including spiro and/or fused rings).

Compounds according to the present invention can be made by the adaptation of methods known to those skilled in the art. One reaction scheme, non-limiting on the scope of the invention, is shown below. 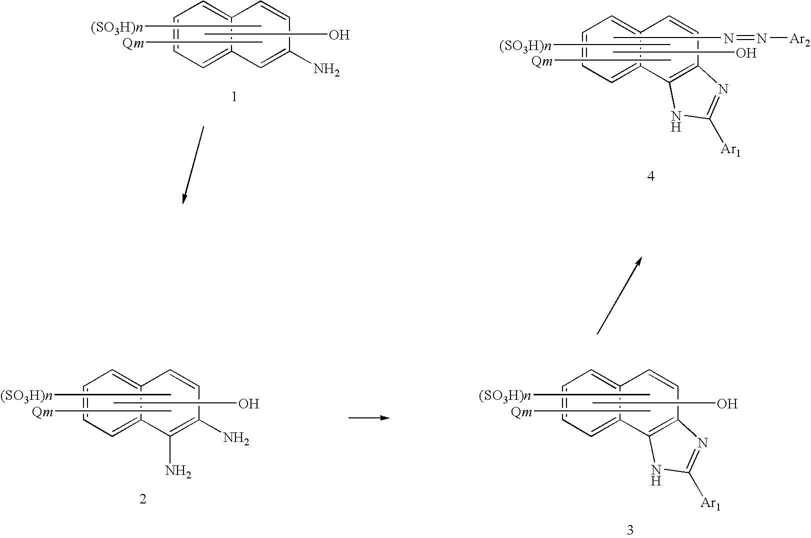
In the above scheme, a compound (2) is prepared from a compound (1) by reaction with a diazonium salt at a pH below 7 followed by reduction of the resulting azo compound with sodium dithionite to yield the compound (2). Condensation with a benzaldehyde derivative (Ar₁CHO) followed by sodium hydrogensulfite affords a benzimidazole compound (3). Further reaction with, for example, diazonium compounds results in formation of the compound (4). Specific examples of preparation methods, each non-limiting on the scope of the invention, are described below.

The compound of Formula (1-1) or Formula (1-2) is preferably provided in a salt form. Preferred salts are alkali metal salts, especially lithium, sodium and potassium salts, ammonium and substituted ammonium salts or mixed salts thereof. Especially preferred salts are salts with ammonia and volatile amines, lithium and sodium. The compounds may be converted into a salt using known techniques.

The compound of Formula (1-1) or Formula (1-2) may exist in tautomeric forms (tautomers) other than those shown in this specification and, accordingly, Formula (1-1) or Formula (1-2) includes all possible tautomeric forms of the compound. Thus, all other tautomeric forms are included within the scope of the present invention and the claims of this specification.

The compound of Formula (1-1) or Formula (1-2) may exist in isomeric and/or isotopic forms other than those shown in this specification and, accordingly, Formula (1-1) or Formula (1-2) includes all possible in isomeric and/or isotopic forms of the compound. Thus, all other in isomeric and/or isotopic forms are included within the scope of the present invention and the claims of this specification.

Among suitable ink compositions are those ink compositions known in the art.

The ink composition of the invention may be an ink composition comprising:
(a) from 0.01 to 30 parts of a compound of Formula (1-1) or Formula (1-2) or a salt thereof; and
(b) from 70 to 99.99 parts of a liquid medium or a low melting point solid medium;
   wherein all parts are by weight and the number of parts of (a)+(b)=100.

The number of parts of component (a) is preferably from 0.1 to 20, more preferably from 0.5 to 15, and especially from 1 to 5 parts. The number of parts of component (b) is preferably from 99.9 to 80, more preferably from 99.5 to 85, especially from 99 to 95 parts.

When the medium is a liquid, preferably component (a) is completely dissolved in component (b). Preferably component (a) has a solubility in component (b) at 20° C. of at least 10%. This allows the preparation of concentrates which may be used to prepare more dilute inks and reduces the chance of the compound precipitating if evaporation of the liquid medium occurs during storage.

Preferred liquid media include water, a mixture of water and an organic solvent and an organic solvent free from water. Most preferably, the liquid medium is a mixture of water and an organic solvent

When the medium comprises a mixture of water and an organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents.

Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol (pentane-1,5-diol), hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably the liquid medium comprises water and 2 or more, especially from 2 to 8, water-soluble organic solvents.

Especially preferred water-soluble organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

A preferred liquid medium comprises:
(a) from 75 to 95 parts water; and
(b) from 25 to 5 parts in total of one or more solvents selected from diethylene glycol, 2-pyrrolidone, thiodiglycol, N-methylpyrrolidone, cyclohexanol, caprolactone, caprolactam and pentane-1,5-diol;
   wherein the parts are by weight and the sum of the parts (a) and (b)=100.

Another preferred liquid medium comprises:
(a) from 60 to 80 parts water;
(b) from 2 to 20 parts diethylene glycol; and
(c) from 0.5 to 20 parts in total of one or more solvents selected from 2-pyrrolidone, N-methylpyrrolidone, cyclohexanol, caprolactone, caprolactam, pentane-1,5-diol and thiodiglycol;
   wherein the parts are by weight and the sum of the parts (a), (b) and (c)=100.

Examples of further suitable liquid media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises an organic solvent free from water, (i.e. less than 1% water by weight) the solvent preferably has a boiling point of from 30° to 200° C., more preferably of from 40° to 150° C., especially from 50 to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the compound in the liquid medium. Examples of polar solvents include C₁₋₄-alcohols. In view of the foregoing preferences it is especially preferred that where the liquid medium is an organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is an organic solvent free from water it is a mixture of 2 to 5 different organic solvents. This allows a medium to be selected which gives good control over the drying characteristics and storage stability of the ink composition.

Liquid media comprising an organic solvent free from water are particularly useful where fast drying times are required and particularly when printing onto hydrophobic and non-absorbent substrates, for example plastics, metal and glass.

Preferred low melting solid media have a melting point in the range from 60° C. to 125° C. Suitable low melting point solids include long chain fatty acids or alcohols, preferably those with C₁₈₋₂₄ chains, and sulphonamides. The compound of Formula (1-1) or Formula (1-2) may be dissolved in the low melting point solid or may be finely dispersed in it.

The ink composition may also contain additional components known for use in ink jet printing inks, for example viscosity and surface tension modifiers, corrosion inhibitors, biocides, kogation reducing additives and surfactants which may be ionic or non-ionic. Examples of these components can be easily found in the literature

Typically the liquid medium will further comprise one or more surfactants, for example anionic and/or nonionic surfactants. Examples of anionic surfactants include: sulphonate surfactants such as sulphosuccinates (Aerosol™ OT, A196; AY and GP, available from CYTEC) and sulphonates (Aerosol™ DPOS-45, OS available from CYTEC; Witconate™ C-50H available from WITCO; Dowfax™ 8390 available from DOW); and fluoro surfactants (Fluorad™ FC99C available from 3M). Examples of nonionic surfactants include: fluoro surfactants (Fluorad™ FC170C available from 3M); alkoxylate surfactants (Tergitol™ series 15S-5, 15S-7, and 15S-9 available from Union Carbide); and organosilicone surfactants (Silwet™ L-77 and L-76-9 available from WITCO). The Surfynol™ range of surfactants (available from Air Products) may also be suitable.

In one embodiment inks according to the invention have a pH of from about 3 to about 5, preferably from about 3.5 to about 4.5. In another embodiment the pH of the composition is preferably from 4 to 11, more preferably from 7 to 10. Optionally the ink composition comprises a buffer.

One or more buffers may optionally be included in the liquid medium to modulate pH of the ink. The buffers can be organic-based biological buffers or inorganic buffers, preferably, organic-based. Examples of preferred buffers include tris(hydroxymethyl)aminomethane (TRIS), available from companies such as Aldrich Chemical (Milwaukee, Wis.), 4-morpholine ethanesulphonic acid (MES), 4-morpholinepropanesulphonic acid (MOPS), and beta-hydroxy-4-morpholinepropanesulphonic acid (MOPSO). Further, the buffers employed preferably provide a pH ranging from 3 to 10 in the practice of the invention.

One or more of the biocides commonly employed in ink jet inks may optionally be used in the ink, such as Nuosept™ 95, available from Huls America (Piscataway, N.J.); Proxel™ GXL, available from Arch Chemicals, Inc. (Norwalk, Conn.), and glutaraldehyde, available from Union Carbide Company (Bound Brook, N.J.) under the trade designation Ucarcide 250.

Inks according to the invention may optionally also include one or more metal chelators. Such chelators are used to bind any free transition metal cations that may be present in the ink. Examples of preferred metal chelators include: ethylenediaminetetraacetic acid (“EDTA”), diethylenediaminepentaacetic acid (“DPTA”), trans-1,2-diaminocyclohexanetetraacetic acid (“CDTA”), ethylenedinitrilotetraacetic acid (“EGTA”). Other chelators may be employed additionally or alternatively.

The viscosity of the ink at 25° C. is preferably less than 50 cP, more preferably less than 20 cP and especially less than 5 cP.

Ink compositions of the present invention suitable for use in an ink-jet printer preferably contain less than 500 ppm, more preferably less than 250 ppm, especially less than 100 ppm, more especially less than 10 ppm in total of divalent and trivalent metal ions (other than any divalent and trivalent metal ions bound to a compound of Formula (1-1) or Formula (1-2) or any other component of the ink).

Preferably, ink compositions of the present invention suitable for use in an ink-jet printer have been filtered through a filter having a mean pore size below 10 μm, more preferably below 3 μm, especially below 2 μm, more especially below 1 μm. This filtration removes particulate matter that could otherwise block the fine nozzles found in many ink-jet printers.

When the ink according to the invention is used in ink jet printing, the ink preferably has a concentration of less than 500 parts per million, more preferably less than 100 parts per million of halide ions.

The compound of Formula (1-1) or Formula (1-2) or a salt thereof may be used as the sole colorant in the ink composition because of its attractive shade, which may be magenta or black, preferably magenta or black and most preferably black. However, if desired, one may combine the compound of Formula (1-1) or Formula (1-2) or a salt thereof together with one or more further colorants to reduce nozzle blockage (by improving their solubility) or if a slightly different shade is required for a particular end use. Thus, inks according to the present invention may be obtained which comprise at least one further colorant. The further colorants are preferably dyes. When further colorants are included in the composition these are preferably selected from black, magenta, cyan, yellow, violet, orange, blue and green colorants and combinations thereof.

Suitable further black colorants include C.I. Food Black 2, C.I. Direct Black 19, C.I. Reactive Black 31, PRO-JET™ Fast Black 2 (PRO-JET™ is a trade mark of Fujifilm Imaging Colorants Limited), C.I. Direct Black 195; C.I. Direct Black 168; other black colorants made or sold by original equipment manufacturers (OEMs) including Lexmark, Seiko Epson, Canon and Hewlett-Packard or by colorant manufacturers including Fuji Photo Film Co., Nippon Kayaku and Mitsubishi and other black colorants described in patents and patent applications by OEMs including the aforesaid Lexmark (e.g. EP 0 539,178 A2, Example 1, 2, 3, 4 and 5), Orient Chemicals (e.g. EP 0 347 803 A2, pages 5-6, azo dyes 3, 4, 5, 6, 7, 8, 12, 13, 14, 15 and 16), Canon, Hewlett-Packard and Seiko Epson Corporation or by colorant manufacturers including Fuji Photo Film Co., Nippon Kayaku and Mitsubishi.

Suitable further magenta colorants include PRO-JET™ Fast Magenta 2 and other magenta colorants made by, sold by or described in patents and patent applications by OEMs including Lexmark, Seiko Epson, Canon and Hewlett-Packard or colorant manufacturers including Fuji Photo Film Co., Nippon Kayaku and Mitsubishi.

Suitable further yellow colorants include C.I. Direct Yellow 142; C.I. Direct Yellow 132; C.I. Direct Yellow 86; PRO-JET™ Yellow OAM; PRO-JET™ Fast Yellow 2; C.I. Direct Yellow 85; C.I. Direct Yellow 173; and C.I. Acid Yellow 23 and other yellow colorants made by, sold by or described in patents and patent applications by OEMs including Lexmark, Seiko Epson, Canon and Hewlett-Packard or colorant manufacturers including Fuji Photo Film Co., Nippon Kayaku and Mitsubishi.

Suitable further cyan colorants include phthalocyanine colorants, C.I. Direct Blue 199 and C.I. Acid Blue 9 and other cyan colorants made by, sold by or described in patents and patent applications by OEMs including Lexmark, Seiko Epson, Canon and Hewlett-Packard or colorant manufacturers including Fuji Photo Film Co., Nippon Kayaku and Mitsubishi.

The ink composition used in the process for printing an image is preferably an ink composition as defined in the above aspect of the present invention.

The ink composition is preferably applied to the substrate using an ink jet printer. In that case, the ink jet printer preferably applies the ink to the substrate in the form of droplets which are ejected through a small orifice onto the substrate. Preferred ink jet printers are piezoelectric ink jet printers and thermal ink jet printers. In thermal ink jet printers, programmed pulses of heat are applied to the ink in a reservoir by means of a resistor adjacent to the orifice, thereby causing the ink to be ejected in the form of small droplets directed towards the substrate during relative movement between the substrate and the orifice. In piezoelectric ink jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are papers which have an acid, alkaline or neutral character. Examples of commercially available papers include HP Premium Coated Paper™, HP Photopaper™, HP Printing paper™ (available from Hewlett Packard Inc.); Stylus Pro 720 dpi Coated Paper™, Epson Photo Quality Glossy Film™, Epson Photo Quality Glossy Paper™ (all available from Seiko Epson Corp.); Canon HR 101 High Resolution Paper™, Canon GP 201 Glossy Paper™, Canon HG 101 and HG201 High Gloss Film™, Canon PR101™ (all available from Canon); Kodak Premium Photopaper, Kodak Premium InkJetpaper™ (available from Kodak); Konica Inkjet Paper QP™ Professional Photo Glossy, Konica Inkjet Paper QP™ Professional Photo 2-sided Glossy, Konica Inkjet Paper QP™ Premium Photo Glossy, Konica Inkjet Paper QP™ Premium Photo Silky™ (available from Konica) and Xerox Acid Paper (available from Xerox).

The compounds of Formula (1-1) or Formula (1-2) or a salt thereof and ink compositions of the present invention provide prints of attractive, magenta/black, especially black, shades that are particularly well suited for the ink jet printing of images (including text). The ink compositions have good storage stability and low tendency to block the very fine nozzles used in ink jet printers. Furthermore, the resultant images have good optical density, light-fastness, wet-fastness and resistance to fading in the presence of oxidising air pollutants (e.g. ozone). The compounds have especially good light-fastness and resistance to fading in the presence of oxidising air pollutants (e.g. ozone).

According to a still further aspect of the present invention there is provided a substrate on which an image has been printed by the process of the present invention as hereinbefore defined. Preferably, the substrate comprises a paper, an overhead projector slide or a textile material.

When the substrate is a textile material the process for printing an image preferably comprises:
i) applying the ink composition to the textile material using an ink jet printer; and
ii) heating the resultant printed textile material at a temperature of from 50° C. to 250° C.

Preferred textile materials are natural, synthetic and semi-synthetic materials. Examples of preferred natural textile materials include wool, silk, hair and cellulosic materials, particularly cotton, jute, hemp, flax and linen. Examples of preferred synthetic and semi-synthetic materials include polyamides, polyesters, polyacrylonitriles and polyurethanes.

Preferably the textile material has been treated with an aqueous pre-treatment composition comprising a thickening agent and optionally a water-soluble base and a hydrotropic agent and dried prior to step i) above.

The pre-treatment composition preferably comprises a solution of the base and the hydrotropic agent in water containing the thickening agent. Particularly preferred pre-treatment compositions are described more fully in European Patent Application No. 534660A1.

According to a yet still further aspect of the present invention there is provided an ink jet printer cartridge, optionally refillable, comprising one or more chambers and an ink composition, wherein the ink composition is present in at least one of the chambers and the ink composition is an ink composition according to the present invention as herein defined.

According to another aspect of the present invention there is provided an ink set comprising at least a black ink, a magenta ink, a cyan ink and a yellow ink and wherein the black ink comprises a compound of Formula (1-1) or Formula (1-2) or a salt thereof as hereinbefore defined and/or an ink composition as hereinbefore defined.

According to another aspect of the present invention there is provided an ink set comprising at least a black ink, a magenta ink, a cyan ink and a yellow ink and wherein the magenta ink comprises a compound of Formula (1-1) or Formula (1-2) or a salt thereof as hereinbefore defined and/or an ink composition as hereinbefore defined.

According to still another aspect of the present invention there is provided use of a compound of Formula (1-1) or Formula (1-2) or a salt thereof as hereinbefore defined to provide a printed image having good optical density, light fastness, wet fastness or resistance to fading in the presence of oxidising gases.

In this specification, unless the context clearly indicates otherwise, as used herein plural forms of the terms herein are to be construed as including the singular form and vice versa.

Throughout the description and claims of this specification, unless the context clearly indicates otherwise, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

The invention is now further illustrated by the following Examples in which all parts and percentages are by weight unless otherwise stated. The Examples are only illustrative of the invention and are not limiting on the scope of the invention. In other words, the examples do not encompass all options, but merely illustrate some the possibilities.

### EXAMPLE 1

Preparation of a Compound of structure:

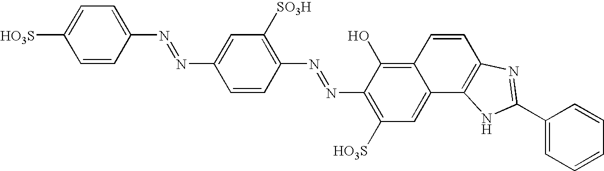

### Stage 1: Preparation of 1,2-diamino-7-sulfo-5-naphthol

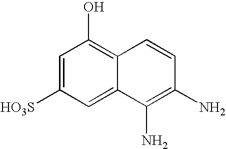

Sulfanilic acid (34.6 g, 0.2 mole) was stirred in water (400 mls) and dissolved with the addition of 10% sodium hydroxide to pH 5. Sodium nitrite (16.6 g, 0.24 mole) was added and this solution was added over 10 minutes at 0-5° C. to a mixture of 36% hydrochloric acid (60 mls) and water (400 mls). The reaction mixture was stirred for 1 hour at 0-5° C. and then the excess nitrous acid was destroyed by the addition of sulfamic acid solution. To this diazo solution was added at 0-5° C., a solution of 6-amino-3-sulfo-1-naphthol monohydrate (51.4 g, 0.2 mole) in water (500 mls), adjusted to pH 7 with 10% sodium hydroxide solution. The reaction mixture was stirred for 3 hours at 0-5° C. then 15% w/v sodium chloride was added. The product precipitated and was collected by filtration and washed with saturated sodium chloride solution. This paste was added to water (1000 mls), adjusted to pH 8 with 10% sodium hydroxide solution and heated to 50-55° C. Sodium dithionite (84 g at 85%, 0.4 mole) was added in small portions over 30 minutes. The reaction mixture was stirred a further 15 minutes then salted to 15% w/v with sodium chloride and cooled to room temperature. The product was recovered by filtration, washed with saturated sodium chloride solution and dried. Yield 28 g, (55%).

### Stage 2: Preparation of 6-hydroxy-2-phenyl-3H-naphtho[1,2d]imidazoles-8-sulfonic acid

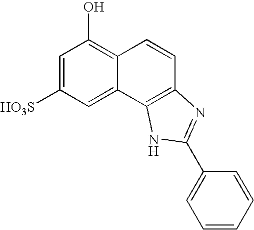

1,2-diamino-7-sulfo-5-naphthol (12.7 g, 0.05 mole) and benzaldehyde (5.3 g, 0.05 mole) were stirred in ethanol (250 mls) at room temperature. A 40% w/v solution of sodium hydrogensulfite (25 mls) was added and the mixture heated at reflux for 3 hours. The reaction mixture was cooled to room temperature. The product recovered by filtration, washed with ethanol and dried. Yield 13.8 g, (80%).

### Stage 3: Preparation of Dye

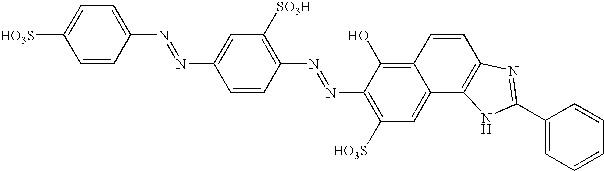

4-amino-1,1′-azobenzene-3,4′-disulfonic acid (CI Acid Yellow 9, 3.8 g, 0.01 mole) was stirred in water (50 mls) and dissolved by the addition of 10% sodium hydroxide to pH 7.5. Sodium nitrite (0.8 g, 0.011 mole) was added. This solution was added dropwise at 0-5° C. to a mixture of 36% hydrochloric acid (8 mls) and water (50 mls). Stirred for 1 hour at 0-5° C. and then the excess nitrous acid was destroyed by the addition of sulfamic acid solution. The diazo solution was added dropwise at 0-5° C. to a solution of the naphthol prepared in stage 2 (3.4 g, 0.01 mole) in water (50 mls) maintaining the pH of the reaction at 10 by the addition of 10% sodium hydroxide solution. The reaction mixture was stirred for 1 hour at 0-5° C. The pH of the reaction mixture was reduced to 6 with hydrochloric acid and the product recovered by filtration. The crude product was dissolved in dilute sodium hydroxide solution and desalinated by dialysis using Visking tubing. The product was recovered from solution by evaporation to dryness. Yield 3.0 g, (40%).

### EXAMPLE 2

Preparation of a Compound of structure:

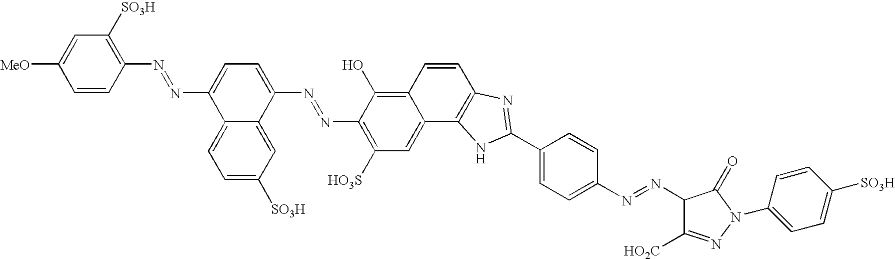

### Stage 1: Preparation of 5-hydroxy-7-sulfo-2-(4-aminophenyl)-naphth-[1,2d]-imidazole

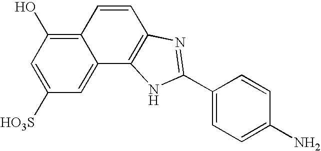

1,2-diamino-7-sulfo-5-naphthol ((prepared in Example 1, stage 1) 19.1 g, 0.075 mole) and 4-acetamidobenzaldehyde (12.2 g, 0.075 moles) were stirred in ethanol (350 mls) at room temperature. A 40% w/v solution of sodium hydrogensulfite (37.5 mls) was added and the mixture heated at reflux for 1 hour. The reaction mixture was cooled to room temperature. The intermediate acetamido product was recovered by filtration, washed with ethanol and dried.

The acetamido intermediate was added to 10% sodium hydroxide (250 mls) and the resulting solution heated at 90° C. for 3 hours. The reaction mixture was cooled down and 10% w/v sodium chloride was added. The pH of the mixture was adjusted to 6 with hydrochloric acid and the product collected by filtration and dried. Yield 20 g, (75%).

### Stage 2

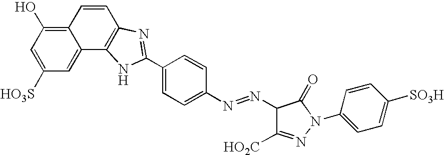

The aminonaphthol prepared in stage 1 (14.2 g, 0.04 mole) was suspended in water (300 mls) and dissolved by the addition of 10% sodium hydroxide to pH 10.5. Sodium nitrite (3.2 g, 0.046 mole) was then added. This solution was added at 0-5° C. to a mixture of 36% hydrochloric acid (20 mls) and water (100 mls). The reaction mixture was stirred for 1 hour at 0-5° C. and then the excess nitrous acid was destroyed by the addition of sulfamic acid solution. A solution of 1-(4′-sulfophenyl)-3-carboxy-5-pyrazolone (11.2 g, 0.04 mole) in water (100 mls) at pH7 with 10% sodium hydroxide solution was added to the diazonium mixture. Pyridine was then added to the reaction mixture to raise the pH to 5. The mixture was stirred a further hour at 0-5° C. and then the pH was reduced to 4 with hydrochloric acid. The product was recovered by filtration, washed with 20% sodium chloride solution and dried. Yield 24.7 g, (95%).

### Stage 3: Preparation of Dye

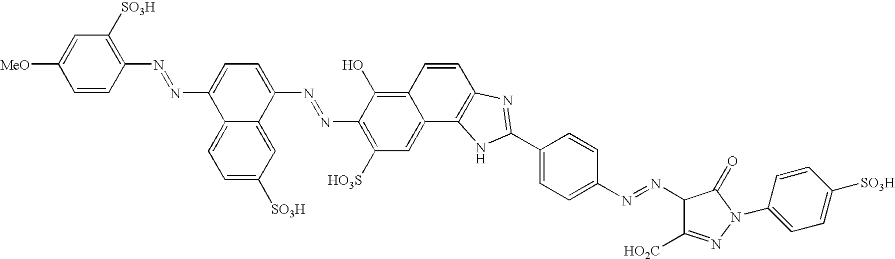

8-amino-5-(4′-methoxy-2′-sulfophenylazo)-2-naphthalenesulfonic acid (4.4 g, 0.01 mole) was stirred in water (50 mls) and dissolved by the addition of 10% sodium hydroxide to pH 7.Sodium nitrite (0.8 g, 0.011 mole) was added and stirred to dissolve. This solution was added at 0-5° C. to a mixture of 36% hydrochloric acid and water (25 mls). The reaction mixture was stirred for 1 hour at 0-5° C. and then the excess nitrous acid destroyed by the addition of sulfamic acid solution. This diazonium solution was added dropwise at 0-5° C. to a solution of the coupler (6.5 g, 0.01 mole) in water (100 mls) maintaining the pH of the reaction at 9-10 by the addition of 10% sodium hydroxide solution. The reaction mixture was stirred for 1 hour then sodium chloride added to 25% w/v and the pH reduced to 5 by addition of hydrochloric acid. The product was recovered by filtration and desalinated by dissolving in dilute sodium hydroxide solution and dialysing using Visking tubing. The product was recovered from solution by evaporation to dryness. Yield 1.6g, (13%).

### EXAMPLE 3

Preparation of Compound:

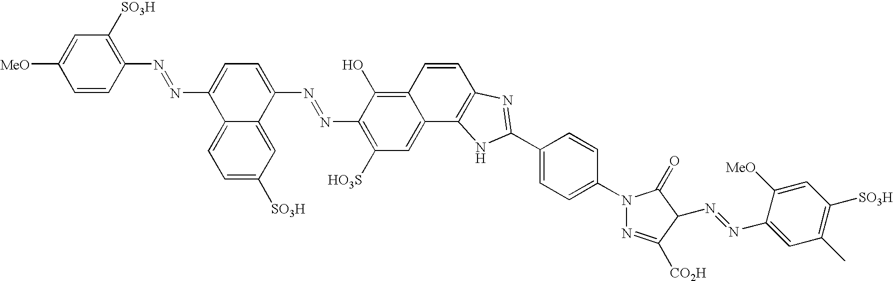

### Stage 1: Preparation of:

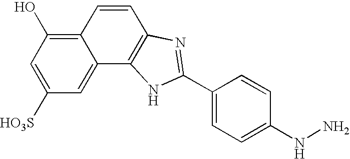

The aminonaphthol prepared in Example 2, stage 1 (23.1 g, 0.065 mole) was stirred in a mixture of water (130 mls) and 36% hydrochloric acid (20 mls) and cooled to 0-5° C. Sodium nitrite (5.3 g, 0.077 mole) was added in small portions and the mixture stirred for 1 hour at 0-5° C. before destroying the excess nitrous acid with sulfamic acid solution. A solution of tin (II) chloride (26.9 g, 0.143 mole) in 36% hydrochloric acid (130 mls) was added slowly at 0-10° C. and the mixture stirred for 1 hour. The product was recovered by filtration, washed with 10% sodium chloride solution and dried. Yield 22.8 g, (86%).

### Stage 2: Preparation of:

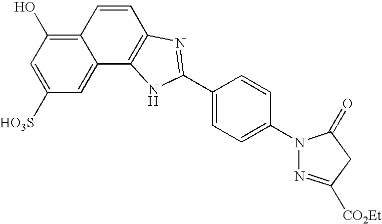

The product from stage 1 (8.1 g, 0.02 mole) and sodium diethyloxalacetate (4.2 g, 0.02 mole) were stirred at reflux in ethanol (50 mls) for 1.5 hours. The product was recovered by filtration, washed with ethanol and dried. Yield 8.1 g, (75%).

### Stage 3: Preparation of:

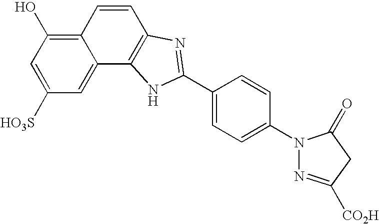

The ester product from stage 2 (5.4 g, 0.01 mole) was stirred in 6% sodium hydroxide solution (50 mls) for 2 hours. The solution was acidified with hydrochloric acid and the product recovered by filtration, washed well with water and dried. Yield 4.6 g (98%).

### Stage 4: Preparation of:

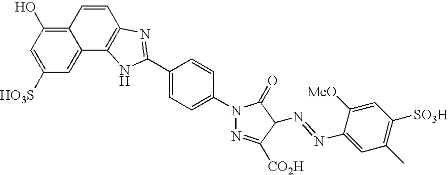

4-amino-3-methoxytoluene-6-sulfonic acid (2.2 g, 0.01 mole) was stirred in water (150 mls) and dissolved by the addition of 10% sodium hydroxide to pH 8. Sodium nitrite (0.8 g, 0.01 mole) was added and stirred to dissolve. This solution was added dropwise to a mixture of 36% hydrochloric acid (3 mls) and water (10 mls) at 0-5° C. Stirred for 1 hour then destroyed the excess nitrous acid with sulfamic acid solution.

The product from stage 3 (4.7 g, 0.01 mole) was stirred in water (75 mls) and dissolved by the addition of 10% sodium hydroxide to pH 8. This solution was added to the diazonium mixture at 0-5° C. After 10 minutes, the pH of the mixture was raised to 4 by the addition of solid sodium acetate. The reaction mixture was stirred for 2 hours at 0-5° C. The product was recovered by filtration, washed with 15% sodium chloride solution and dried. Yield 5.3 g, (77%)

### Stage 5: Preparation of Dye

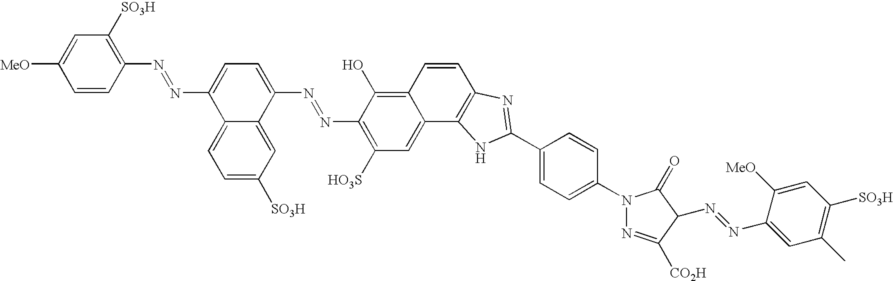

The dye was prepared by the same method as Example 2, stage 3, but using the product of stage 4 (6.9 g, 0.01 mole) in place of example 2, stage 2. Yield 2 g, (16%)

### EXAMPLES 4-23

The compounds shown in Table 1A were prepared by analogous methods to those described in detail above in Examples 1 to 3.

TABLE 1A

| | | Prepared |
|---|---|---|
| | | analogously |
| Ex- | | to |
| am- | | example |
| ple | Compound | number |
| 4 | 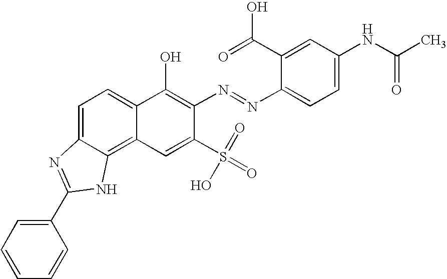 | 1 |
| 5 | 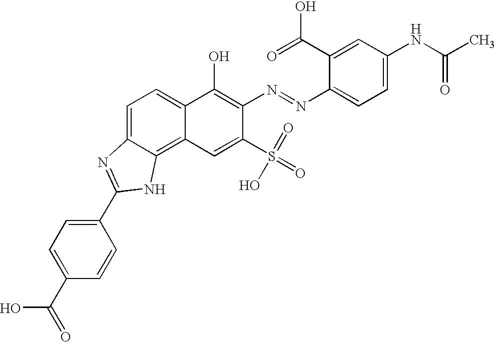 | 1 |
| 6 | 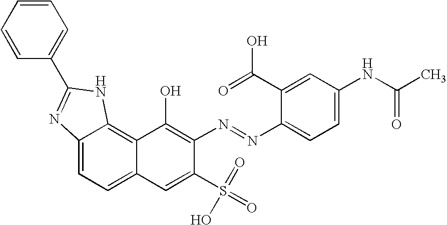 | 1 |
| 7 | 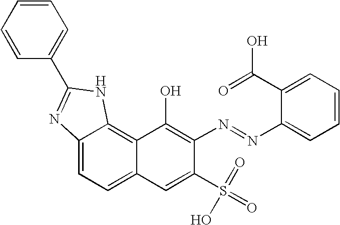 | 1 |
| 8 | 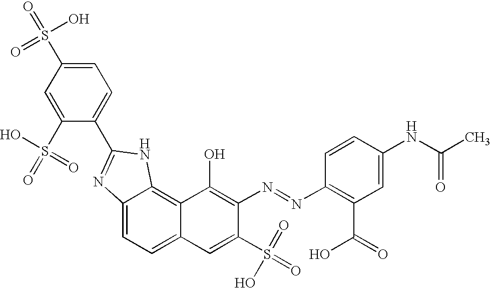 | 1 |
| 9 | 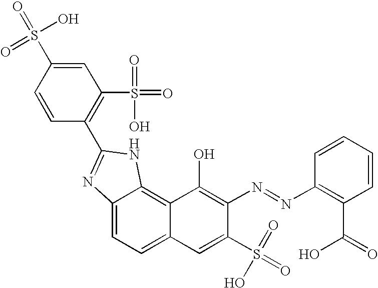 | 1 |
| 10 | 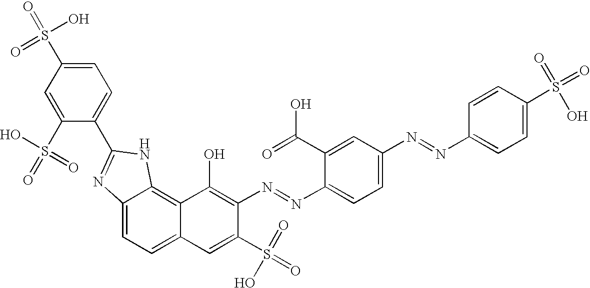 | 1 |
| 11 | 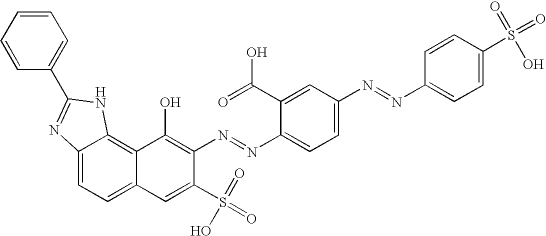 | 1 |
| 12 | 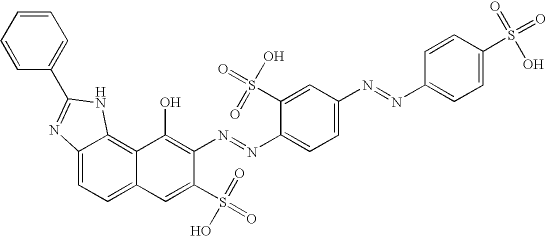 | 1 |
| 13 | 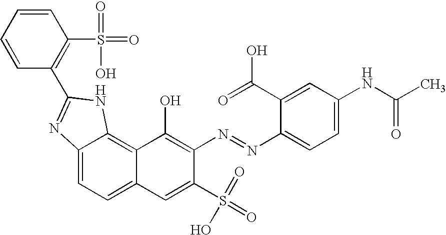 | 1 |
| 14 | 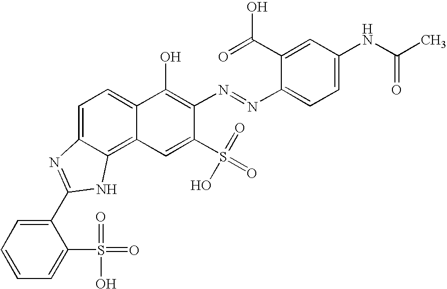 | 1 |
| 15 | 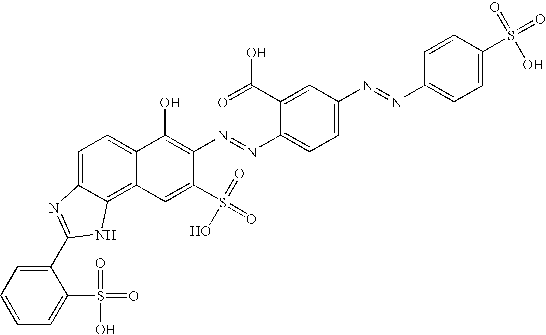 | 1 |
| 16 | 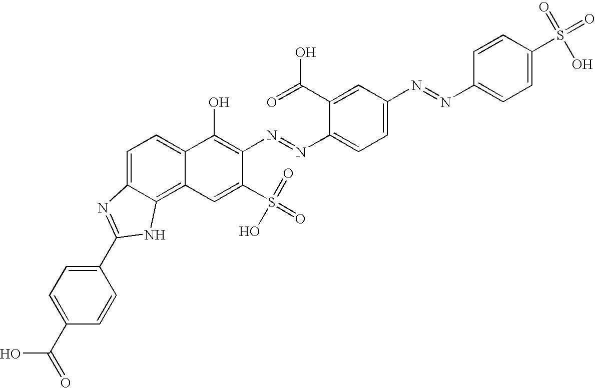 | 1 |
| 17 | 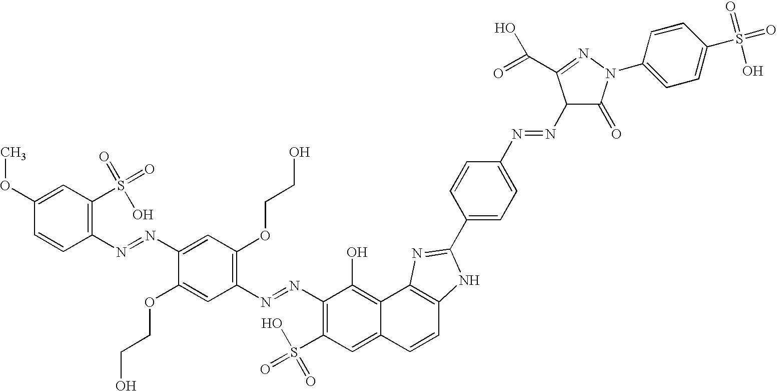 | 2 |
| 18 | 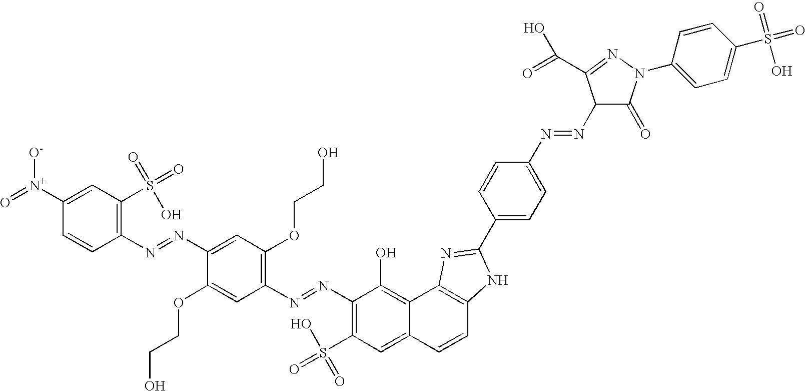 | 2 |
| 19 | 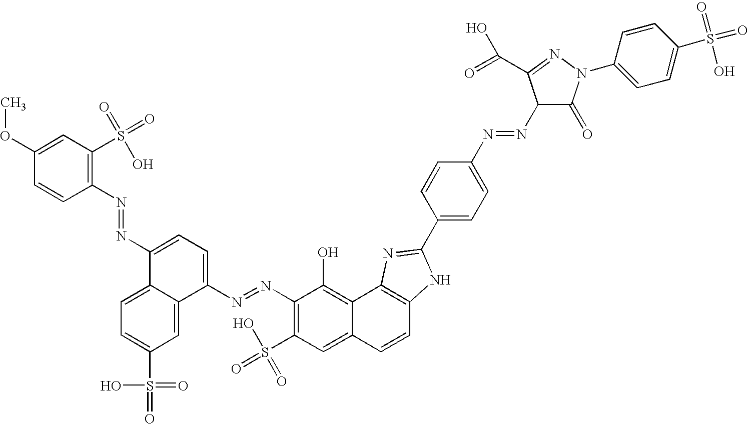 | 2 |
| 20 | 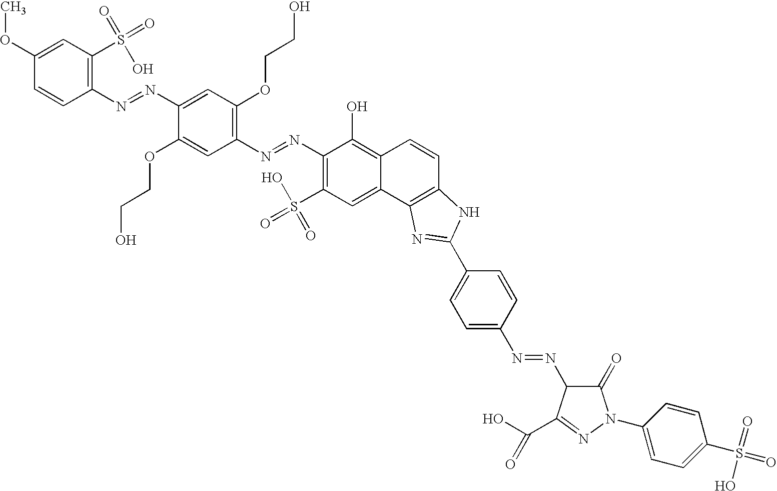 | 2 |
| 21 | 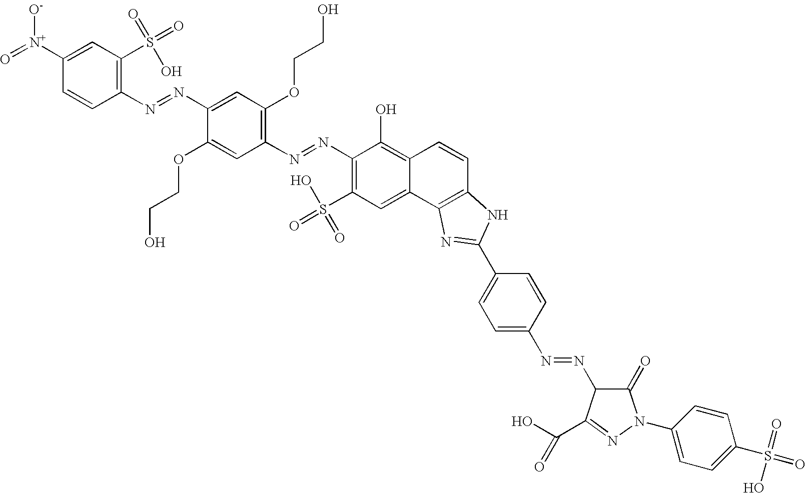 | 2 |
| 22 | 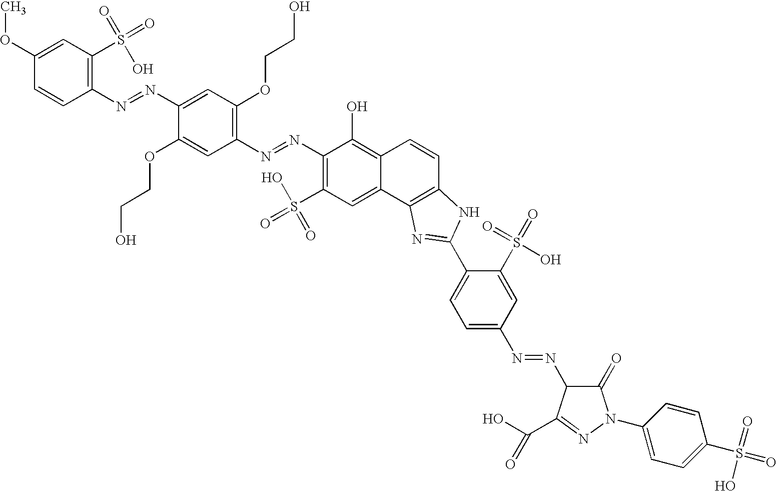 | 2 |

### EXAMPLES 24-31

The compounds shown in Table 1B may be prepared by analogous methods to those described in detail above in Examples 1 to 3.

TABLE 1B

| | | Can be |
|---|---|---|
| | | prepared |
| | | analogously |
| | | to example |
| Example | Compound | number |
| 24 | 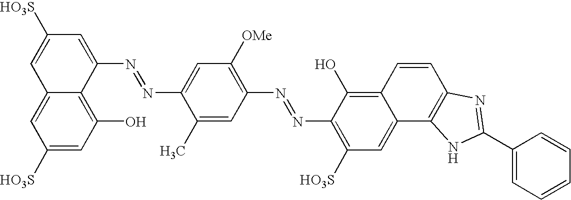 | 1 |
| 25 | 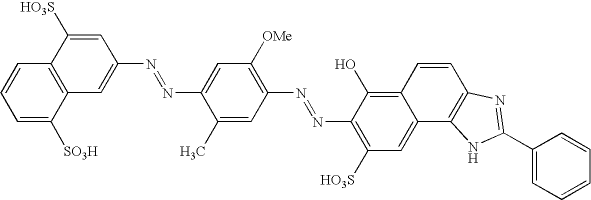 | 1 |
| 26 | 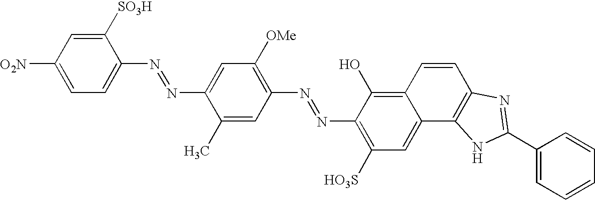 | 1 |
| 27 | 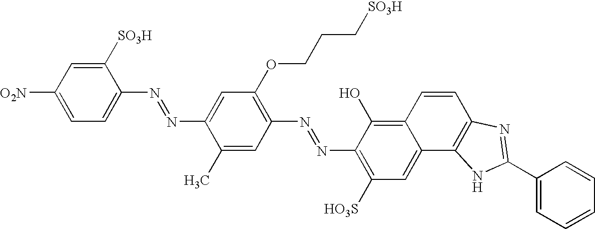 | 1 |
| 28 | 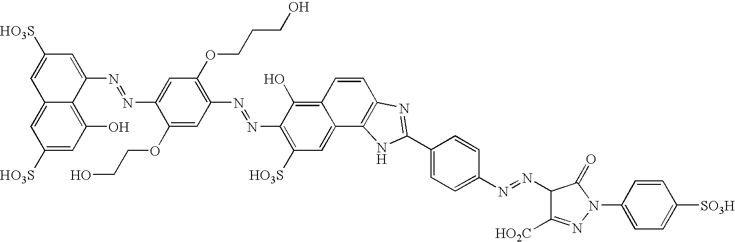 | 2 |
| 29 | 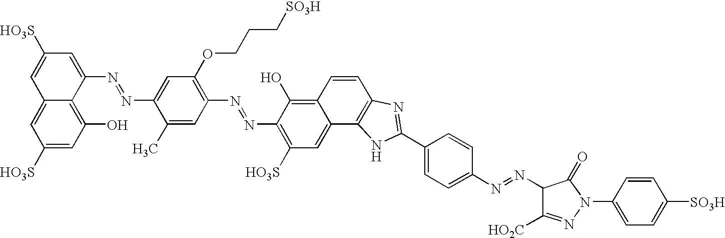 | 2 |
| 30 | 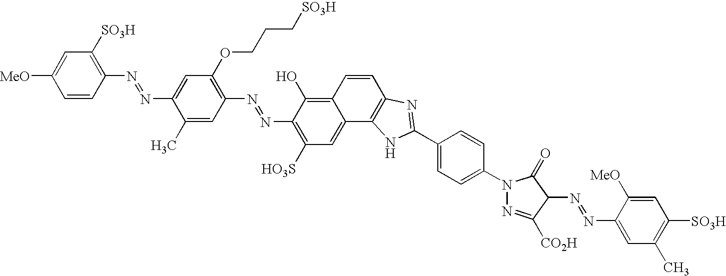 | 3 |
| 31 | 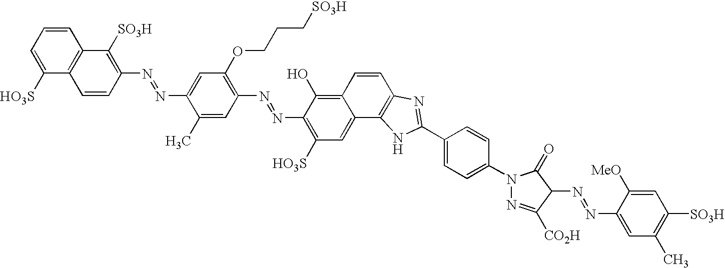 | 3 |

### EXAMPLE 32

### Ink Formulations

Inks may be prepared according to the following formulation wherein Dye is a Compound, or mixture of two or more Compounds, from the above Examples:

| | |
|---|---|
| 2-Pyrrolidone | 5 parts |
| Thiodiglycol | 5 parts |
| Surfynol ™ 465 | 1 part (from Air Products Inc., USA) |
| Dye | 3 parts |
| Water | 86 parts |

Further inks described in Tables 2 to 5 may be prepared wherein the Dye described in the first column is the compound made in the above Example of the same number. Numbers quoted in the second column onwards refer to the number of parts of the relevant ingredient and all parts are by weight. The inks may be applied to paper by, for example, thermal or piezo ink jet printing.

The following abbreviations are used in Table 2 to 5:

PG=propylene glycol

DEG=diethylene glycol

NMP=N-methyl pyrollidone

DMK=dimethylketone

IPA=isopropanol

MEOH=methanol

2P=2-pyrollidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE 2

| | Compound | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 3 | 10.0 | 85 | 3 | | 3 | 3 | | | | 5 | 1 | |
| 4 | 2.1 | 91 | | 8 | | | | | | | | 1 |
| 5 | 3.1 | 86 | 5 | | | | | 0.2 | 4 | | | 5 |
| 6 | 1.1 | 81 | | | 9 | | 0.5 | 0.5 | | | 9 | |
| 7 | 2.5 | 60 | 4 | 15 | 3 | 3 | | | 6 | 10 | 5 | 4 |
| 8 | 5 | 65 | | 20 | | | | | 10 | | | |
| 9 | 2.4 | 75 | 5 | 4 | | 5 | | | | 6 | | 5 |
| 10 | 4.1 | 80 | 3 | 5 | 2 | 10 | | 0.3 | | | | |
| 11 | 3.2 | 65 | | 5 | 4 | 6 | | | 5 | 4 | 6 | 5 |
| 12 | 5.1 | 96 | | | | | | | | 4 | | |
| 13 | 10.8 | 90 | 5 | | | | | | 5 | | | |
| 14 | 10.0 | 80 | 2 | 6 | 2 | 5 | | | 1 | | 4 | |
| 15 | 1.8 | 80 | | 5 | | | | | | | 15 | |
| 16 | 2.6 | 84 | | | 11 | | | | | | 5 | |
| 17 | 3.3 | 80 | 2 | | | 10 | | | | 2 | | 6 |
| 18 | 12.0 | 90 | | | | 7 | 0.3 | | 3 | | | |
| 19 | 5.4 | 69 | 2 | 20 | 2 | 1 | | | | | 3 | 3 |
| 20 | 6.0 | 91 | | | 4 | | | | | | 5 | |

TABLE 3

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | PI2 |
| 21 | 3.0 | 80 | 15 | | | 0.2 | | | | | 5 | |
| 22 | 9.0 | 90 | | 5 | | | | | | 1.2 | | 5 |
| 23 | 1.5 | 85 | 5 | 5 | | 0.15 | 5.0 | 0.2 | | | | |
| 24 | 2.5 | 90 | | 6 | 4 | | | | | 0.12 | | |
| 25 | 3.1 | 82 | 4 | 8 | | 0.3 | | | | | | 6 |
| 26 | 0.9 | 85 | | 10 | | | | | 5 | 0.2 | | |
| 27 | 8.0 | 90 | | 5 | 5 | | | 0.3 | | | | |
| 28 | 4.0 | 70 | | 10 | 4 | | | | 1 | | 4 | 11 |
| 29 | 2.2 | 75 | 4 | 10 | 3 | | | | 2 | | 6 | |
| 30 | 10.0 | 91 | | | 6 | | | | | | 3 | |
| 31 | 9.0 | 76 | | 9 | 7 | | 3.0 | | | 0.95 | 5 | |
| 1 | 5.0 | 78 | 5 | 11 | | | | | | | 6 | |
| 2 | 5.4 | 86 | | | 7 | | | | | | 7 | |
| 3 | 2.1 | 70 | 5 | 5 | 5 | 0.1 | 0.2 | 0.1 | 5 | 0.1 | 5 | |
| 4 | 2.0 | 90 | | 10 | | | | | | | | |
| 5 | 2 | 88 | | | | | | 10 | | | | |
| 6 | 5 | 78 | | | 5 | | | 12 | | | 5 | |
| 7 | 8 | 70 | 2 | | 8 | | | 15 | | | 5 | |
| 8 | 10 | 80 | | | | | | 8 | | | 12 | |
| 9 | 10 | 80 | | 10 | | | | | | | | |

TABLE 4

| | Compound | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 10 | 2.0 | 80 | 5 | | 6 | 4 | | | | | 5 | |
| 11 | 3.0 | 90 | | 5 | 5 | | 0.2 | | | | | |
| 12 | 10.0 | 85 | 3 | | 3 | 3 | | | | 5 | 1 | |
| 13 | 2.1 | 91 | | 8 | | | | | | | | 1 |
| 14 | 3.1 | 86 | 5 | | | | | 0.2 | 4 | | | 5 |
| 15 | 1.1 | 81 | | | 9 | | 0.5 | 0.5 | | | 9 | |
| 16 | 2.5 | 60 | 4 | 15 | 3 | 3 | | | 6 | 10 | 5 | 4 |
| 17 | 5 | 65 | | 20 | | | | | 10 | | | |
| 18 | 2.4 | 75 | 5 | 4 | | 5 | | | | 6 | | 5 |
| 19 | 4.1 | 80 | 3 | 5 | 2 | 10 | | 0.3 | | | | |
| 20 | 3.2 | 65 | | 5 | 4 | 6 | | | 5 | 4 | 6 | 5 |
| 21 | 5.1 | 96 | | | | | | | | 4 | | |
| 22 | 10.8 | 90 | 5 | | | | | | 5 | | | |
| 23 | 10.0 | 80 | 2 | 6 | 2 | 5 | | | 1 | | 4 | |
| 24 | 1.8 | 80 | | 5 | | | | | | | 15 | |
| 25 | 2.6 | 84 | | | 11 | | | | | | 5 | |
| 26 | 3.3 | 80 | 2 | | | 10 | | | | 2 | | 6 |
| 27 | 12.0 | 90 | | | | 7 | 0.3 | | 3 | | | |
| 28 | 5.4 | 69 | 2 | 20 | 2 | 1 | | | | | 3 | 3 |
| 29 | 6.0 | 91 | | | 4 | | | | | | 5 | |

TABLE 5

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | PI2 |
| 30 | 3.0 | 80 | 15 | | | 0.2 | | | | | 5 | |
| 31 | 9.0 | 90 | | 5 | | | | | | 1.2 | | 5 |
| 1 | 1.5 | 85 | 5 | 5 | | 0.15 | 5.0 | 0.2 | | | | |
| 2 | 2.5 | 90 | | 6 | 4 | | | | | 0.12 | | |
| 3 | 3.1 | 82 | 4 | 8 | | 0.3 | | | | | | 6 |
| 4 | 0.9 | 85 | | 10 | | | | | 5 | 0.2 | | |
| 5 | 8.0 | 90 | | 5 | 5 | | | 0.3 | | | | |
| 6 | 4.0 | 70 | | 10 | 4 | | | | 1 | | 4 | 11 |
| 7 | 2.2 | 75 | 4 | 10 | 3 | | | | 2 | | 6 | |
| 8 | 10.0 | 91 | | | 6 | | | | | | 3 | |
| 9 | 9.0 | 76 | | 9 | 7 | | 3.0 | | | 0.95 | 5 | |
| 10 | 5.0 | 78 | 5 | 11 | | | | | | | 6 | |
| 11 | 5.4 | 86 | | | 7 | | | | | | 7 | |
| 12 | 2.1 | 70 | 5 | 5 | 5 | 0.1 | 0.2 | 0.1 | 5 | 0.1 | 5 | |
| 13 | 2.0 | 90 | | 10 | | | | | | | | |
| 14 | 2 | 88 | | | | | | 10 | | | | |
| 15 | 5 | 78 | | | 5 | | | 12 | | | 5 | |
| 16 | 8 | 70 | 2 | | 8 | | | 15 | | | 5 | |
| 17 | 10 | 80 | | | | | | 8 | | | 12 | |
| 18 | 10 | 80 | | 10 | | | | | | | | |

### EXAMPLE 33

### Print Test Evaluation

Preparation of Inks

An ink was prepared using the dye from Example 20 above by dissolving 3.5 g of the dye in 96.5 ml of a liquid medium consisting of 5 parts 2-pyrrolidone; 5 parts thiodiethylene glycol; 1 part Surfynol™ 465 and 89 parts water and adjusting the pH to between pH 8 to 9 with sodium hydroxide. Surfynol™ 465 is a surfactant from Air Products. The ink had a viscosity of less than 20 cP 25° C.; a surface tension in the range 20-65 dynes/cm at 25° C.; less than 500 ppm in total of divalent and trivalent metal ions (other than any divalent and trivalent metal ions bound to the dye or any other component of the ink); and less than 500 ppm in total of halide ions. This ink was called “Ink 1”.

A further ink (“Ink C1”) was prepared in the same way as Ink 1 except that a comparative, prior art dye, C1, was used in place of the dye from Example 20. The comparative dye C1 was prepared as described in example 2 of U.S. Pat. No. 5,053,495 and had the following structure: 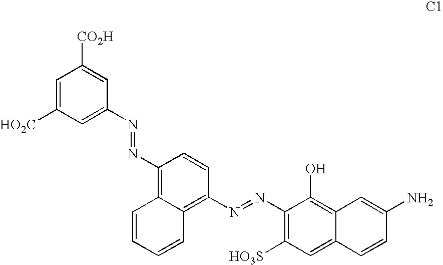
Ink-Jet Printing

Ink 1 and Ink C1 prepared as described above were filtered through a 0.45 micron nylon filter and then incorporated into empty print cartridges using a syringe.

These inks were then printed on to Epson Crispia Photo Paper (Epson Crispia) and HP Premium Plus Photo Paper (HP P+).

The prints were tested for ozone fastness and light fastness in two separate tests. The prints were tested for ozone fastness by exposure to 1 ppm ozone at 40° C., 50% relative humidity for 24 hrs in a Hampden 903 Ozone cabinet. The prints were tested for light fastness by exposure to 70 kLux for 100 hours in an Atlas Ci5000 weatherometer. Fastness of the printed ink is judged by the difference in the optical density before and after exposure to ozone or light, measured at two print depths.

Optical density measurements were performed using a Gretag spectrolino spectrophotometer set to the following parameters:

| | |
|---|---|
| Measuring Geometry: | 0°/45° |
| Spectral Range: | 400-700 nm |
| Spectral Interval: | 20 nm |
| Illuminant: | D65 |
| Observer: | 2° (CIE 1931) |
| Density: | Ansi A |
| External Filler: | None |

Ozone fastness and light fastness were assessed by the percentage change in the optical density of the print, where a lower figure indicates higher fastness. Results are shown in Table 6.

TABLE 6

| | OF^{#} (SEC Crispia | | LF⁻ (SEC Crispia | | LF⁻ | |
|---|---|---|---|---|---|---|
| | paper) | | paper) | | (HP P+ paper) | |
| | 70% | 40% | 70% | 40% | 70% | 40% |
| Example | depth | depth | depth | depth | depth | depth |
| Ink 1 | 0 | 20 | 37 | 76 | 3 | 29 |
| Ink C1 | 31 | 29 | 63 | 87 | 46 | 72 |

^{#}OF = ozone fastness
⁻LF = light fastness

Table 6 shows that the ink of the present invention has a higher ozone fastness and light fastness than the comparative ink.

1. A compound of Formula (1-1) or Formula (1-2) or a salt thereof: 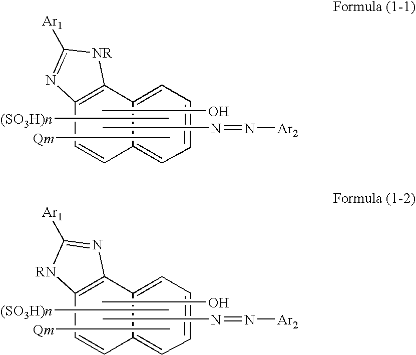
wherein:
Ar₁ and Ar₂ each independently represent an optionally substituted aryl or heteroaryl group with the proviso that where Ar₁ is phenyl substituted with an azo group it is substituted with the azo group at the para position;
R represents H, optionally substituted alkyl, or optionally substituted aryl;
Q is a substituent, which may be another OH group;
n is an integer from 1 to 4;
m is an integer from 0 to 4, wherein each Q may be the same or different in the case where m is more than 1; and
n+m is not greater than 4;
with the proviso that the compound is not one of the following compounds (i) and (ii) and the salt is not a salt thereof:

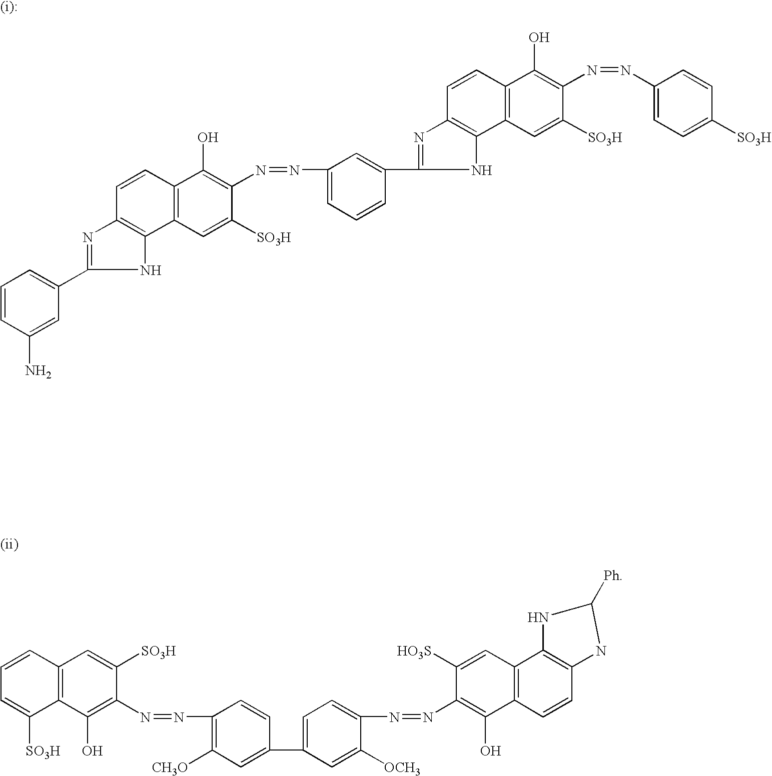

2. A compound according to claim 1 which is of either of the following formulae or a salt thereof:

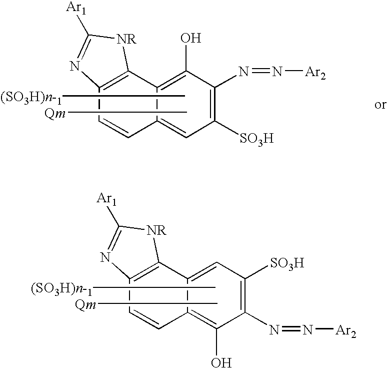

3. A compound according to claim 1 or 2 which is of the following formula or a salt thereof: 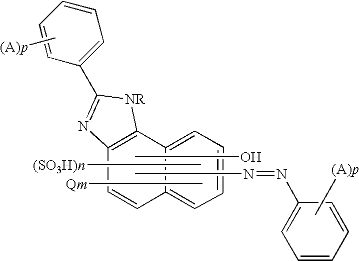
wherein p is an integer from 0 to 4 and each A independently is a substituent selected from optionally substituted alkyl, optionally substituted alkoxy, optionally substituted aryl, optionally substituted heteroaryl, optionally substituted aryloxy, optionally substituted amino, hydroxy, halogen, cyano, nitro, silyl, silyloxy, sulpho, phosphate, COOR¹, OCOOR¹, OCOR¹, COR¹, CONR¹R², OCONR¹R², SR¹, SO₂NR¹R², or SO₂R¹, wherein R² is H, optionally substituted alkyl, or optionally substituted aryl.

4. A compound or salt according to claim 1 or 2 wherein Ar₂ is at least substituted with an optionally substituted arylazo or optionally substituted heteroarylazo group.

5. A compound or salt according to claim 4 wherein Ar₂ is also substituted with one or two groups selected from optionally substituted C₁₋₄alkyl, optionally substituted C₁₋₄alkoxy and optionally substituted —O—(CH₂)₁₋₄—OH.

6. A compound or salt according to any one of claims 1, 2, 4 and 5 wherein Ar₁ is at least substituted with an optionally substituted heteroaryl group, an optionally substituted arylazo group or an optionally substituted heteroarylazo group.

7. A compound or salt according to any one preceding claim wherein the compound carries at least two water solubilising groups selected from carboxy, sulpho and phosphato.

8. A salt according to any one preceding claim which is a salt selected from the group consisting of lithium, sodium, potassium, ammonium and substituted ammonium salts or mixed salts thereof.

9. An ink composition which comprises a liquid medium and a compound or a salt thereof according to any one of claims 1 to 8.

10. A process for printing an image on a substrate, the process comprising applying to the substrate an ink composition according to claim 9 without the proviso that the compound is not one of the following compounds (i) and (ii) and the salt is not a salt thereof.

11. A substrate on which an image has been printed by the process according to claim 10, wherein the substrate comprises a paper, an overhead projector slide or a textile material.

12. An ink jet printer cartridge, optionally refillable, comprising one or more chambers and an ink composition present in at least one of the chambers, wherein the ink composition is an ink composition according to claim 9 without the proviso that the compound is not one of the compounds (i) and (ii) and the salt is not a salt thereof.
